(19) United States
(12) Patent Application Publication
(10) Pub. No.: US 2026/0228663 A1
(43) Pub. Date: Aug. 6, 2026

(54) New Computer Feature Prioritization

(71) Applicant: Dell Products L.P., Round Rock, TX (US)

(72) Inventors: Ophir Buchman, Raanana (IL); Yevgeni Gehtman, Modi'in (IL); Omer Aharony, Newton, MA (US)

(21) Appl. No.: 19/046,290

(22) Filed: Feb. 5, 2025

(51) Int. Cl. G06Q 10/0631; G06F 8/70; H04M 3/22

(52) U.S. Cl. CPC G06Q 10/06315; G06F 8/70; H04M 3/2281

(57) ABSTRACT

A system can determine that an issue with first computing equipment is resolved via developing a new feature. The system can, in response to the new feature being omitted from a future feature list, add an identification of the new feature to the list. The system can, in response to the new feature being identified in the list, increase a vote count for the new feature. The system can, in response to the new feature being offered as part of second computing equipment, increase a priority value of the new feature in the list. The system can, in response to the new feature not being offered as part of the second computing equipment, decrease the priority value of the new feature in the list. The system can determine that development of the new feature is to occur based on the vote count and the priority value.

### BACKGROUND

Computers can experience problems, and a cause of a problem can be identified, such as in a support call between a user of the computer and a vendor of the computer. It can also be a resolution to the problem can involve implementing a new feature that is not currently offered by the vendor.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. The system can, as part of a support call regarding an issue with first computing equipment associated with a vendor identity corresponding to a vendor, determine that the issue with the first computing equipment is resolved via developing a new product feature, wherein the new product feature is omitted from the first computing equipment, and wherein the new product feature is omitted from computing equipment products associated with the vendor identity. The system can determine whether the new product feature is identified in a future feature list, to produce a first result. The system can, in response to the first result indicating that the new product feature is omitted from the future feature list, add an identification of the new product feature to the future feature list. The system can, in response to the first result indicating that the new product feature is identified in the future feature list, increase a vote count for the new product feature. The system can, after the determining of whether the new product feature is identified in the future feature list, determine whether the new product feature is offered as part of second computing equipment associated with a different vendor identity associated with a different vendor, to produce a second result. The system can, in response to the second result indicating that the new product feature is offered as part of the second computing equipment, increase a priority value of the new product feature in the future feature list. The system can, in response to the second result indicating that the new product feature is not offered as part of the second computing equipment, decrease the priority value of the new product feature in the future feature list. The system can determine that development of the new product feature is to occur based on the vote count for the new product feature and based on the priority value of the new product feature in the future feature list.

An example method can comprise determining, by a system comprising at least one processor, that an issue with computing equipment supplied by a vendor is able to be resolved via developing a new product feature, wherein the new product feature is omitted from the computing equipment, and wherein the new product feature is omitted from computing equipment products supplied by the vendor. The method can further comprise, where the new product feature is omitted from a future feature list, adding, by the system, an identification of the new product feature to the future feature list. The method can further comprise, where the new product feature is identified in the future feature list, increasing, by the system, a vote count for the new product feature. The method can further comprise, where the new product feature is determined to be offered by a competitor to the vendor, increasing, by the system, a priority value of the new product feature in the future feature list. The method can further comprise, where the new product feature is determined not to be offered by the competitor to the vendor, decreasing, by the system, the priority value of the new product feature in the future feature list. The method can further comprise facilitating, by the system, development of the new product feature based on the vote count for the new product feature and based on the priority value of the new product feature in the future feature list.

An example non-transitory computer-readable medium can comprise instructions that, in response to execution, cause a system comprising a processor to perform operations. These operations can comprise determining that an issue with computing equipment associated with a vendor identity of a vendor is able to be resolved by developing a new product feature. These operations can further comprise, based on the new product feature being determined to be omitted from a feature list of product features that have not yet been developed, adding an identification of the new product feature to the feature list. These operations can comprise, based on the new product feature being determined to be identified in the feature list, increasing a vote count for the new product feature. These operations can comprise, based on the new product feature being determined to be available via other equipment associated with another vendor identity of another vendor, increasing a priority value of the new product feature in the feature list. These operations can comprise, based on the new product feature being determined not to be available via the other equipment, decreasing the priority value of the new product feature in the feature list.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate new computer feature prioritization, in accordance with an embodiment of this disclosure;

FIG. 2 illustrates an example that can facilitate new computer feature prioritization, in accordance with an embodiment of this disclosure;

FIG. 3 illustrates another example that can facilitate new computer feature prioritization, in accordance with an embodiment of this disclosure;

FIG. 4 illustrates an example of propagating a new feature to other products, and that can facilitate new computer feature prioritization, in accordance with an embodiment of this disclosure;

FIG. 5 illustrates another example of propagating a new feature to other products, and that can facilitate new computer feature prioritization, in accordance with an embodiment of this disclosure;

FIG. 6 illustrates an example process flow for determining whether there is a missing feature or enhancement, and that can facilitate new computer feature prioritization, in accordance with an embodiment of this disclosure;

FIG. 7 illustrates an example process flow for determining whether a feature has already been requested, and that can facilitate new computer feature prioritization, in accordance with an embodiment of this disclosure;

FIG. 8 illustrates an example process flow for determining whether a feature exists within an industry, and that can facilitate new computer feature prioritization, in accordance with an embodiment of this disclosure;

FIG. 9 illustrates an example process flow for determining whether a feature priority is correct, and that can facilitate new computer feature prioritization, in accordance with an embodiment of this disclosure;

FIG. 10 illustrates an example process flow for determining whether a feature is relevant to multiple offerings, and that can facilitate new computer feature prioritization, in accordance with an embodiment of this disclosure;

FIG. 11 illustrates an example process flow that can facilitate new computer feature prioritization, in accordance with an embodiment of this disclosure;

FIG. 12 illustrates another example process flow that can facilitate new computer feature prioritization, in accordance with an embodiment of this disclosure;

FIG. 13 illustrates another example process flow that can facilitate new computer feature prioritization, in accordance with an embodiment of this disclosure; and

FIG. 14 illustrates an example block diagram of a computer operable to execute an embodiment of this disclosure.

### DETAILED DESCRIPTION

### Overview

The present techniques can generally relate to areas such as helping sales representatives identify new leads from support calls. This can facilitate:
1. Helping product managers identify needed features from support calls: using user feedback to improve a vendor's products.
2. Identifying new cross-product features: enhancing a vendor's product offerings through integrated solutions.

Consider a scenario where a call topic prediction mechanism for a support call has identified a user's issue with their computer, and provided at least one resolution step. In some cases, it can be that none of the available resolutions resolve the specific user case due to missing functionality or product limitations.

A vendor of the computer can track and prioritize these feature enhancements to products. Prior techniques generally involve manual prioritization by product managers who might not always be aware of evolving user needs and the competitive landscape.

The present techniques can address these drawbacks with prior approaches, by providing a path for scenarios where an issue can be resolved by developing a new product feature. In such scenarios, a support agent can provide functionality details to a dedicated system that can check whether the functionality already exists in a future feature list. Where it does not, the functionality can be added to the future feature list. Where it does, a vote for that functionality in the future feature list can be added.

Additionally, where the present techniques are implemented by a vendor, the functionality details provided by the support agent to the dedicated system can be used to check whether it is already offered by the vendor's competitors. Where the functionality is not already offered by the vendor's competitors, it can be assigned a lower priority in the feature list. Where the functionality is already offered by the vendor's competitors, it can be assigned a higher priority in the feature list.

Features can be created and/or prioritized accordingly.

The present techniques can facilitate an automatic generation of a feature request following a support call. The present techniques can also facilitate an automatic feature prioritization based on its availability in competitive products (that is, based on the industry state). The present techniques can also facilitate enhanced tracking of feature demand via an automatic vote tracking mechanism.

Again, consider a scenario where a call topic prediction mechanism for a support call has identified a user's issue with their computer, and provided at least one resolution step. In some cases, it can be that none of the available resolutions resolve the specific user case due to missing functionality or product limitations.

Where this missing feature is realistic and transferrable, the present techniques can facilitate tracking and prioritizing the feature against multiple products.

In prior approaches, product managers generally manually prioritize features based on their limited point-of-view. Additionally, product managers generally do not have an eco-system view that includes other products.

The present techniques can apply to scenarios where a new product feature that resolves an issue can be adopted by other products. In such scenarios, a support agent can provide functionality details to a dedicated system that can check whether the functionality already exists in a future feature list. Where it does not, the functionality can be added to the future feature list. Where it does, a vote for that functionality in the future feature list can be added.

Additionally, where the present techniques are implemented by a vendor, the functionality details provided by the support agent to the dedicated system can be used to check whether the functionality is relevant to other of the vendor's products. Where it is not relevant, there can be a single request for the feature. Where it is relevant, the feature request can be shared among multiple products.

Features can be created and/or prioritized accordingly.

The present techniques can be implemented to facilitate automatic feature propagation and prioritization based on user request and feature relevance.

### Example Architectures, Etc.

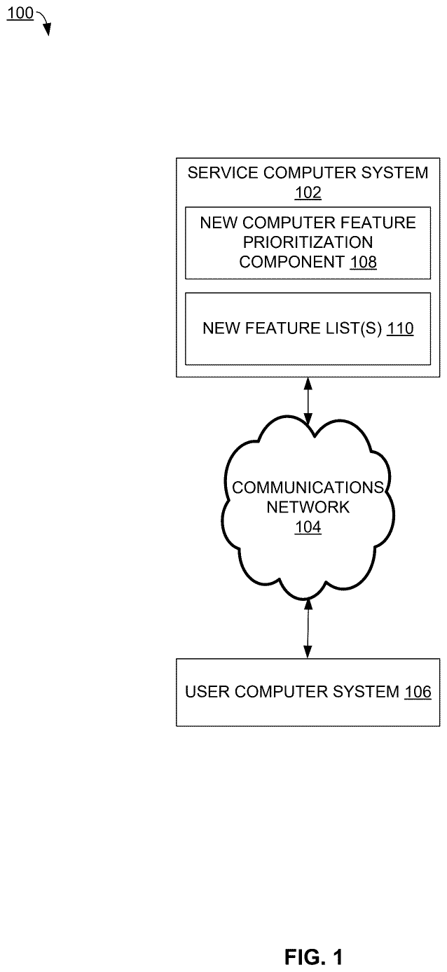

FIG. 1 illustrates an example system architecture 100 that can facilitate new computer feature prioritization, in accordance with an embodiment of this disclosure.

System architecture 100 comprises service computer system 102, communications network 104, and user computer system 106. Service computer system 102 comprises new computer feature prioritization component 108 and new feature list(s) 110.

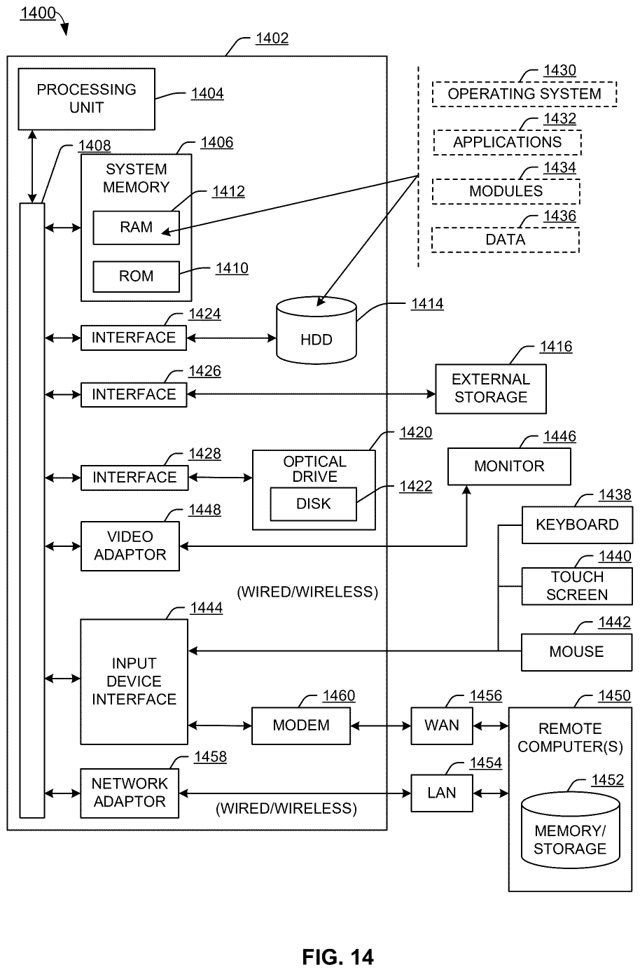

Each of service computer system 102, and/or user computer system 106, can be implemented with part(s) of computing environment 1400 of FIG. 14. Communications network 104 can comprise a computer communications network, such as the Internet.

User computer system 106 can be experiencing an issue or a problem with its operation. As part of fixing this, a support call can be made from a user associated with user computer system 106 to a support agent associated with service computer system 102. As this problem is investigated, it can be determined that a resolution involves a functionality that is not present on service computer system 102. New computer feature prioritization component 108 can add or update (e.g., increase a vote count or modify a priority) this feature in one or more lists of new feature list(s) 110 (where each list can correspond to a different computer product). Selecting features to implement as part of development of a computer product can be based on new feature list(s) 110.

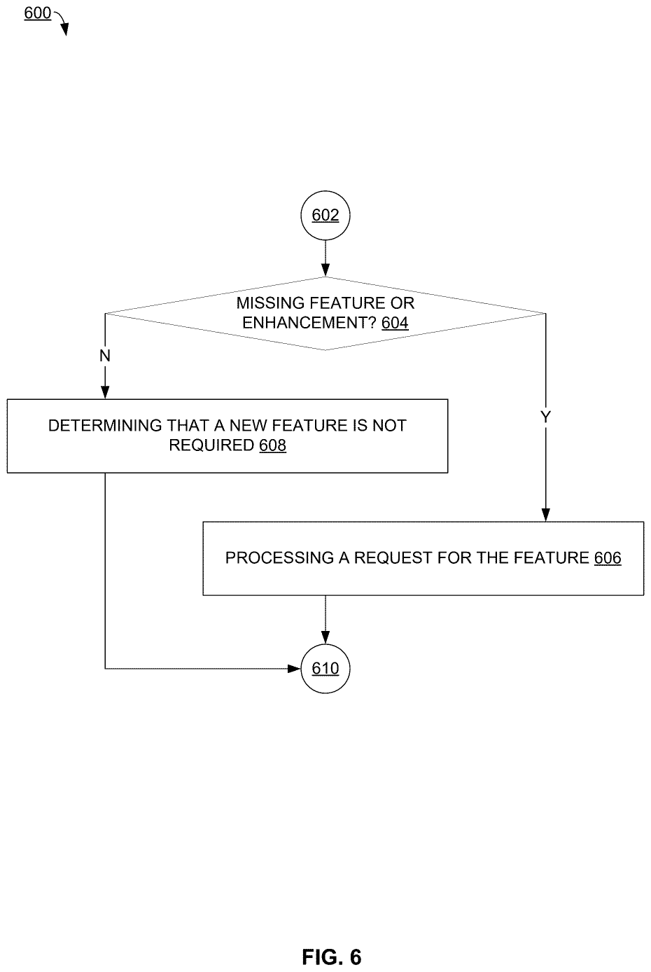

In some examples, new computer feature prioritization component 108 can implement part(s) of the process flows of FIGS. 6-13 to implement new computer feature prioritization.

It can be appreciated that system architecture 100 is one example system architecture for new computer feature prioritization, and that there can be other system architectures that facilitate new computer feature prioritization.

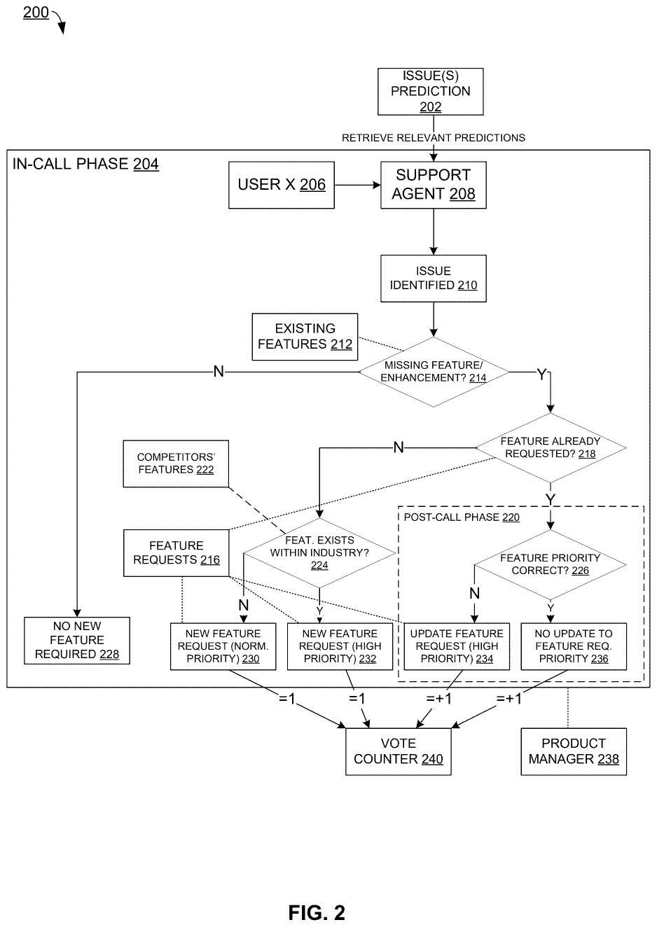

FIG. 2 illustrates an example 200 that can facilitate new computer feature prioritization, in accordance with an embodiment of this disclosure. In some examples, part(s) of example 200 can be implemented by part(s) of system architecture 100 of FIG. 1 to facilitate product offering based on a support call.

Example 200 comprises issue(s) prediction 202, in-call phase 204, user X 206, support agent 208, issue identified 210, existing features 212, missing feature or enhancement? 214, feature requests 216, feature already requested? 218, post-call phase 220, competitors'features 222, feature exists within industry? (competitors) 224, feature priority correct? 226, no new feature required 228, new feature request (normal priority) 230, new feature request (high priority) 232, update feature request (high priority) 234, no update to feature request priority 236, product manager 238, and vote counter 240.

In example 200, a new feature can be requested and prioritized based on a support call.

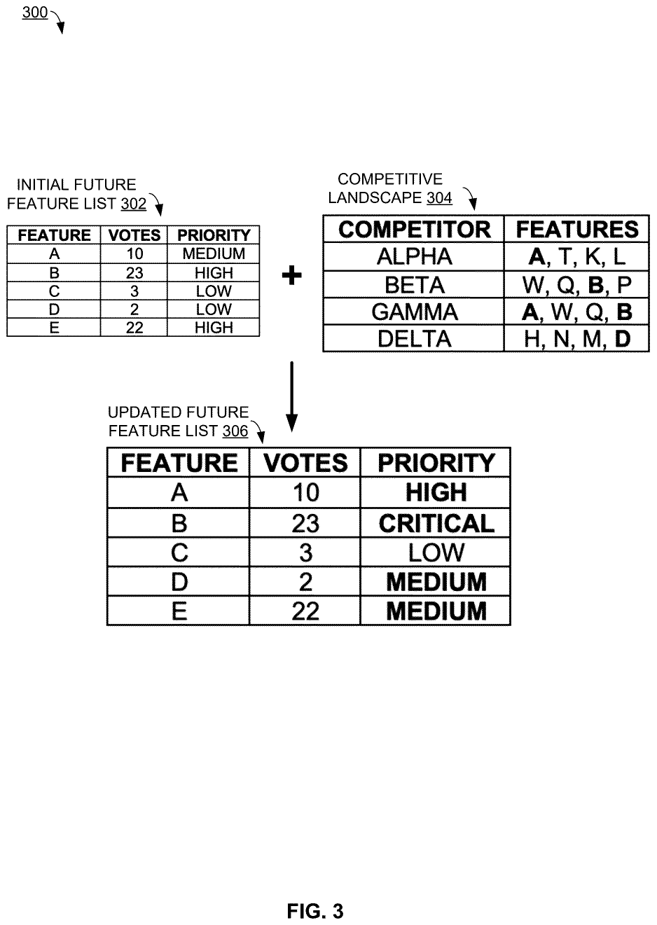

FIG. 3 illustrates another example 300 that can facilitate new computer feature prioritization, in accordance with an embodiment of this disclosure. In some examples, part(s) of example 300 can be implemented by part(s) of system architecture 100 of FIG. 1 to facilitate product offering based on a support call.

Example 300 comprises initial future feature list 302, competitive landscape 304, and updated future feature list 306.

In example 300, a new feature can be requested based on a support call, and the new feature request can be prioritized based on a competitive landscape.

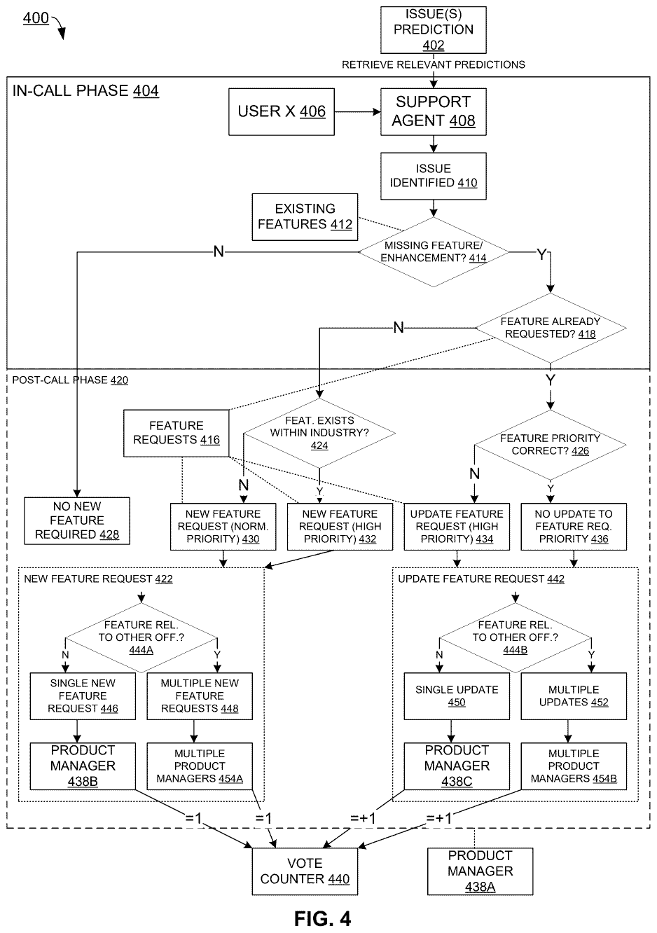

FIG. 4 illustrates an example 400 of propagating a new feature to other products, and that can facilitate new computer feature prioritization, in accordance with an embodiment of this disclosure. In some examples, part(s) of example 400 can be implemented by part(s) of system architecture 100 of FIG. 1 to facilitate product offering based on a support call.

Example 400 comprises issue(s) prediction 402, in-call phase 404, user X 406, support agent 408, issue identified 410, existing features 412, missing feature or enhancement? 414, feature requests 416, feature already requested? 418, post-call phase 420, new feature request 422, feature exists within industry? (competitors) 424, feature priority correct? 426, no new feature required 428, new feature request (normal priority) 430, new feature request (high priority) 432, update feature request (high priority) 434, no update to feature request priority 436, product manager 438A, product manager 438B, product manager 438C, vote counter 440, update feature request 442, is feature relevant to other offerings? 444A, is feature relevant to other offerings? 444B, single new feature request 446, multiple new feature requests 448, single update 450, multiple updates 452, multiple product managers 454A, and multiple product managers 454B.

In example 400, a new feature can be requested and prioritized based on a support call. Where the new feature applies to multiple products, the new feature can be requested and prioritized for each of these multiple products.

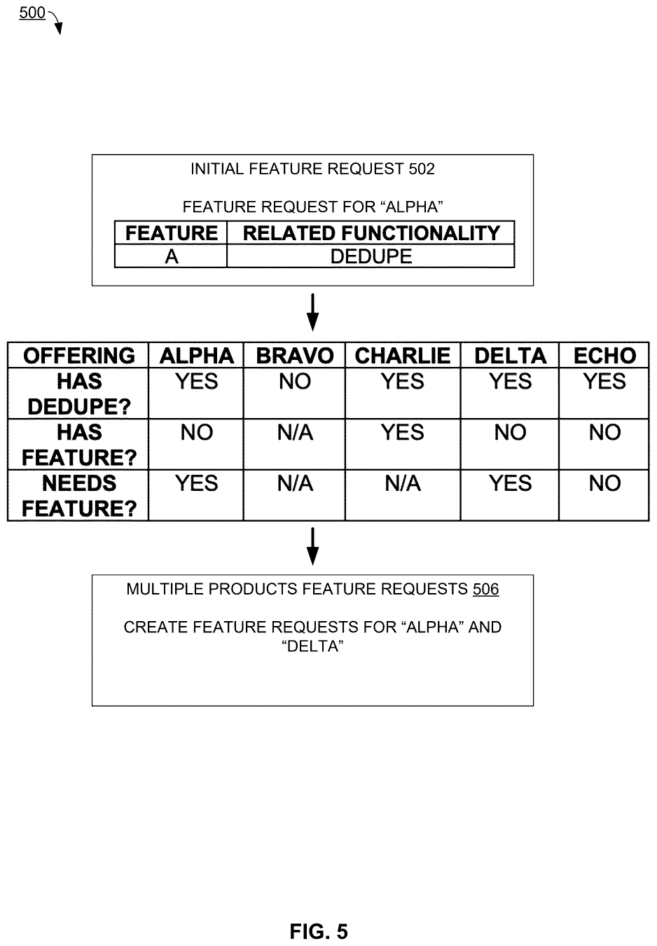

FIG. 5 illustrates another example 500 of propagating a new feature to other products, and that can facilitate new computer feature prioritization, in accordance with an embodiment of this disclosure. In some examples, part(s) of example 500 can be implemented by part(s) of system architecture 100 of FIG. 1 to facilitate product offering based on a support call.

Example 500 comprises initial feature request 502, multiple products information 504, and multiple products feature requests 506.

Example 500 illustrates one example of how a new feature can be requested and prioritized based on a support call, and, where the new feature applies to multiple products, the new feature can be requested and prioritized for each of these multiple products.

### Example Process Flows

FIG. 6 illustrates an example process flow 600 for determining whether there is a missing feature or enhancement, and that can facilitate new computer feature prioritization, in accordance with an embodiment of this disclosure. In some examples, one or more embodiments of process flow 600 can be implemented by new computer feature prioritization component 108 of FIG. 1, or computing environment 1400 of FIG. 14.

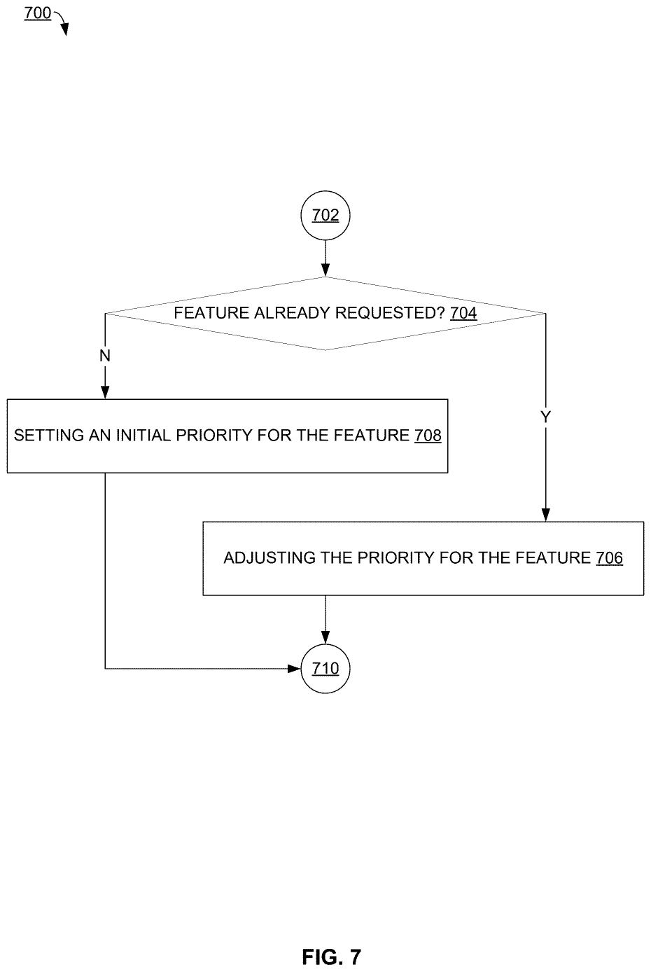

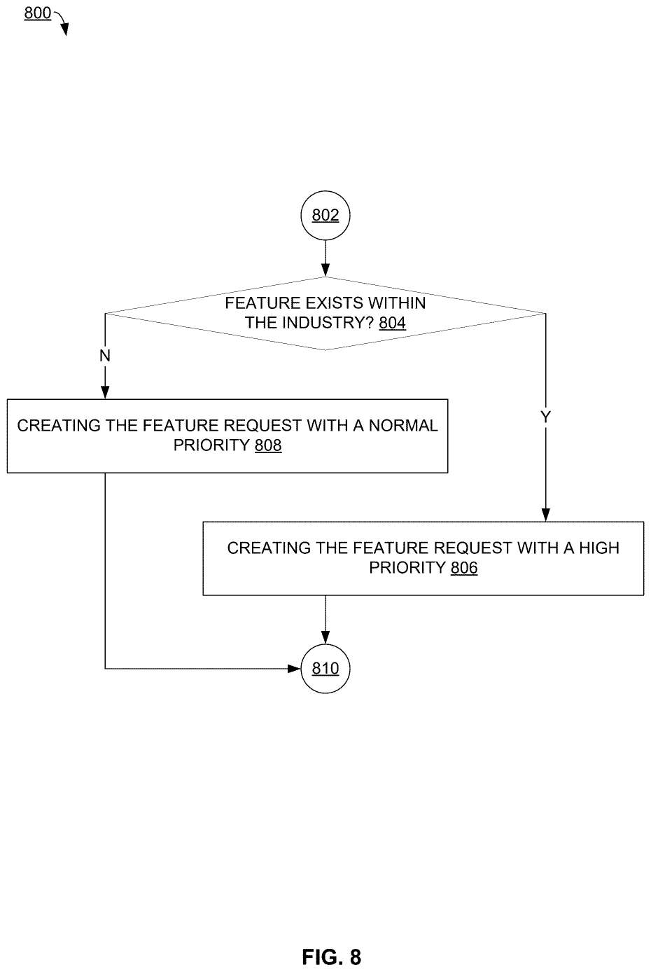

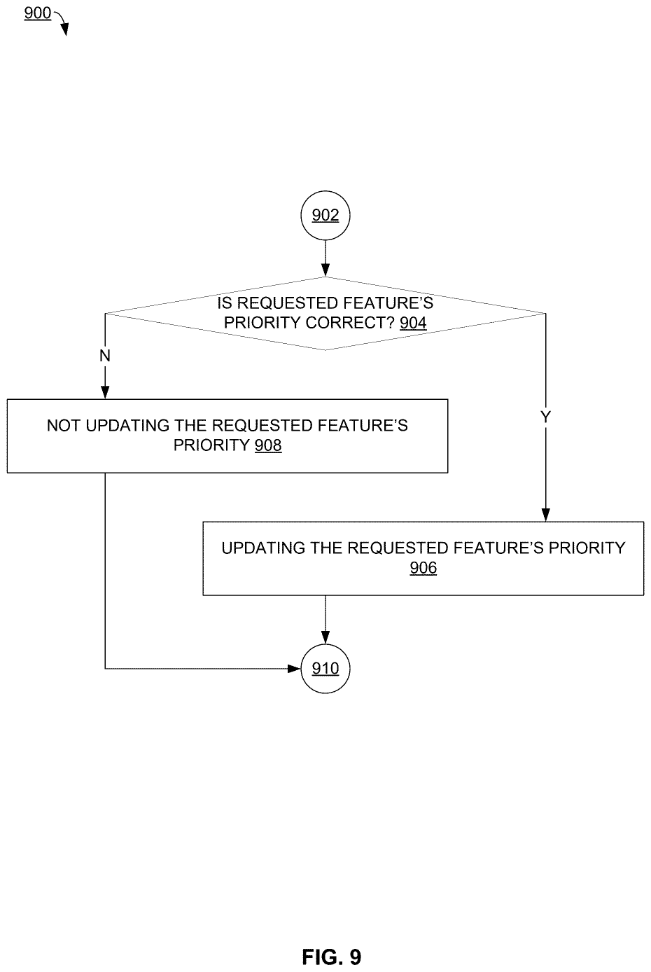

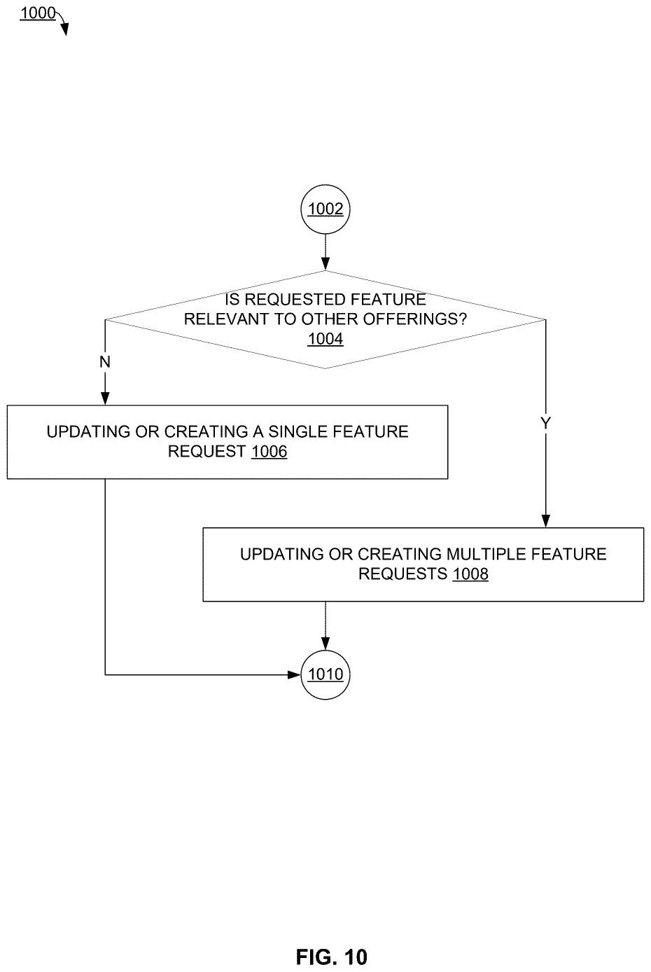

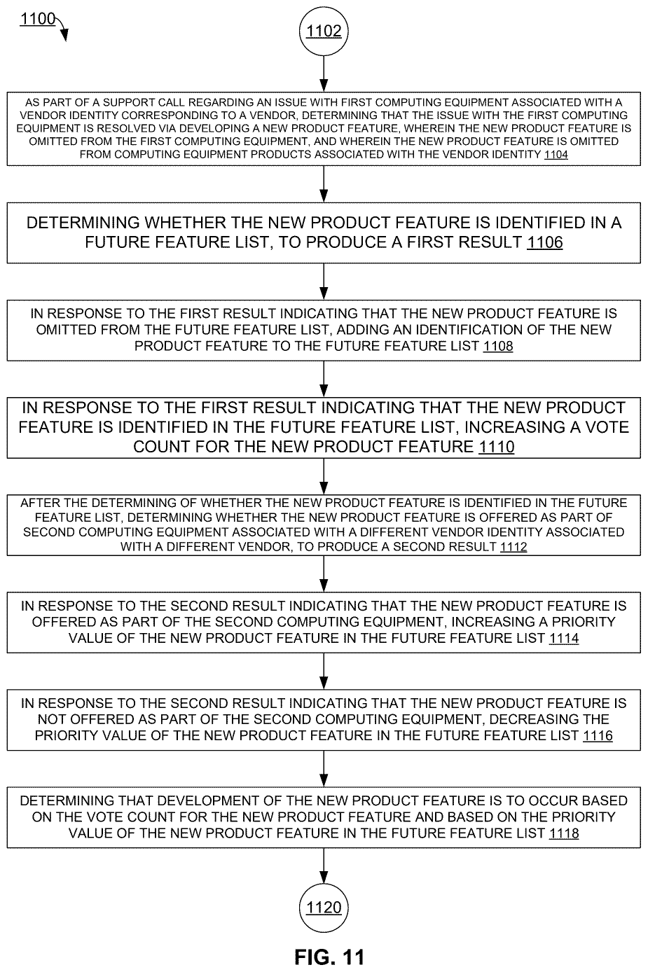

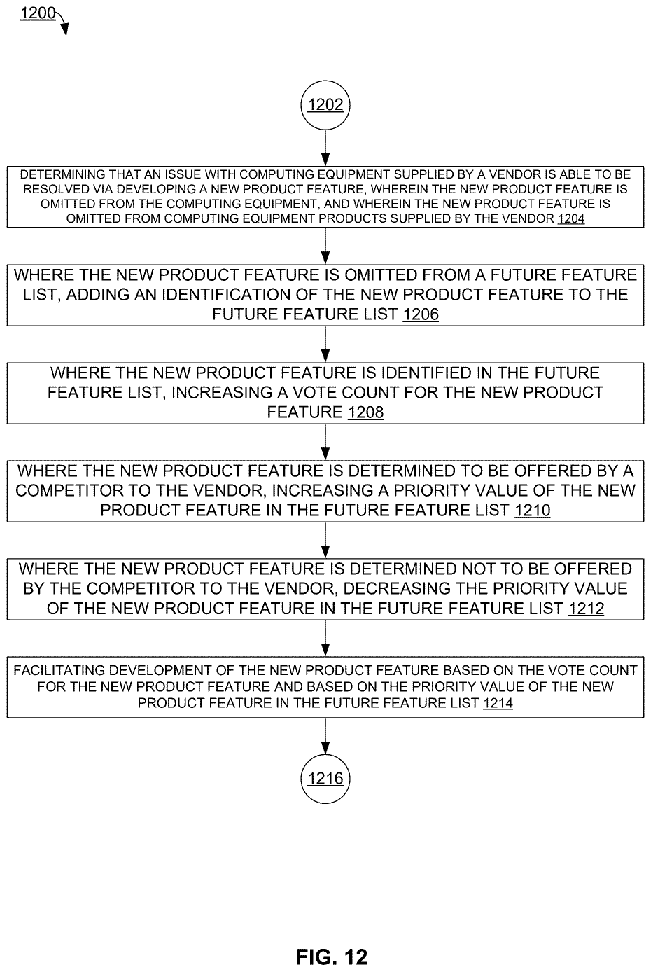

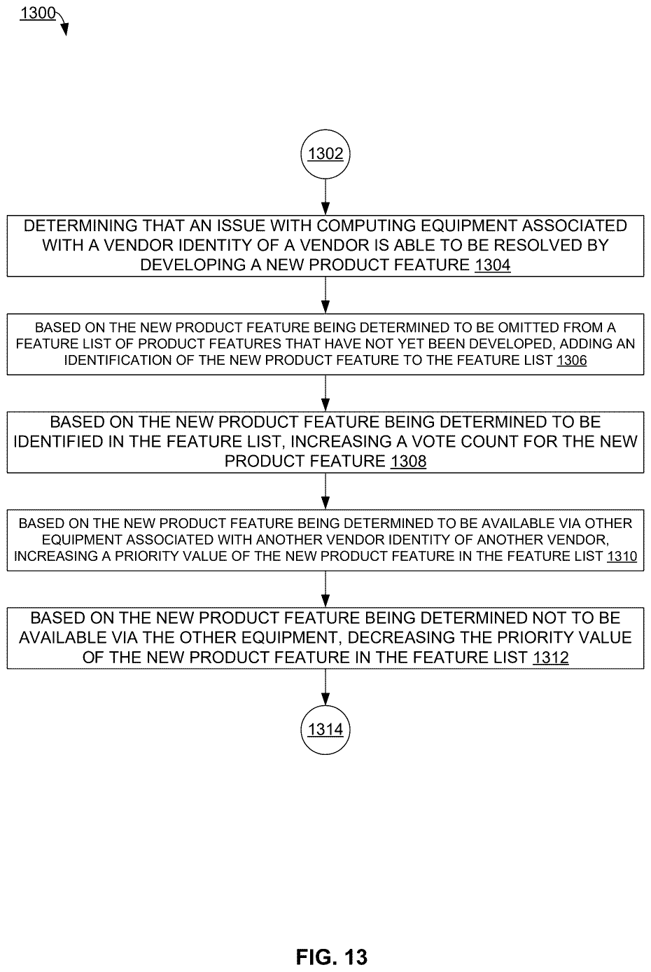

It can be appreciated that the operating procedures of process flow 600 are example operating procedures, and that there can be embodiments that implement more or fewer operating procedures than are depicted, or that implement the depicted operating procedures in a different order than as depicted. In some examples, process flow 600 can be implemented in conjunction with one or more embodiments of one or more of process flow 700 of FIG. 7, process flow 800 of FIG. 8, process flow 900 of FIG. 9, process flow 1000 of FIG. 10, process flow 1100 of FIG. 11, process flow 1200 of FIG. 12, and/or process flow 1300 of FIG. 13.

Process flow 600 begins with 602, and moves to operation 604.

Operation 604 depicts determining whether there is a missing feature or enhancement. In some examples, operation 604 can be implemented in a similar manner as missing feature or enhancement? 214 of FIG. 2.

Where in operation 604 it is determined that there is a missing feature or enhancement, process flow 600 moves to operation 606. Instead, where in operation 604 it is determined that there is a missing feature or enhancement, process flow 600 moves to operation 608.

Operation 606 is reached from operation 604 where it is determined that there is a missing feature or enhancement. Operation 606 depicts processing a request for the feature. In some examples, operation 606 can be implemented in a similar manner as 216-226 and 230-240 of FIG. 2.

After operation 606, process flow 600 moves to 610, where process flow 600 ends.

Operation 608 is reached from operation 604 where it is determined that there is not a missing feature or enhancement. Operation 608 depicts determining that a new feature is not required. In some examples, operation 608 can be implemented in a similar manner as no new feature required 228 of FIG. 2.

After operation 608, process flow 600 moves to 610, where process flow 600 ends.

FIG. 7 illustrates an example process flow 700 for determining whether a feature has already been requested, and that can facilitate new computer feature prioritization, in accordance with an embodiment of this disclosure. In some examples, one or more embodiments of process flow 700 can be implemented by new computer feature prioritization component 108 of FIG. 1, or computing environment 1400 of FIG. 14.

It can be appreciated that the operating procedures of process flow 700 are example operating procedures, and that there can be embodiments that implement more or fewer operating procedures than are depicted, or that implement the depicted operating procedures in a different order than as depicted. In some examples, process flow 700 can be implemented in conjunction with one or more embodiments of one or more of process flow 600 of FIG. 6, process flow 800 of FIG. 8, process flow 900 of FIG. 9, process flow 1000 of FIG. 10, process flow 1100 of FIG. 11, process flow 1200 of FIG. 12, and/or process flow 1300 of FIG. 13.

Process flow 700 begins with 702, and moves to operation 704.

Operation 704 depicts determining whether a feature is already requested. In some examples, operation 704 can be implemented in a similar manner as feature already requested? 218 of FIG. 2.

Where in operation 704 it is determined that the feature is already requested, process flow 700 moves to operation 706. Instead, where in operation 704 it is determined that the feature is not already requested, process flow 700 moves to operation 708.

Operation 706 is reached from operation 704 where it is determined that the feature is already requested. Operation 706 depicts adjusting the priority for the feature. In some examples, operation 706 can be implemented in a similar manner as 226 and 234-236 of FIG. 2.

After operation 706, process flow 700 moves to 710, where process flow 700 ends.

Operation 708 is reached from operation 704 where it is determined that the feature is not already requested. Operation 708 depicts setting an initial priority for the feature. In some examples, operation 708 can be implemented in a similar manner as 224 and 230-232 of FIG. 2.

After operation 708, process flow 700 moves to 710, where process flow 700 ends.

FIG. 8 illustrates an example process flow 800 for determining whether a feature exists within an industry, and that can facilitate new computer feature prioritization, in accordance with an embodiment of this disclosure. In some examples, one or more embodiments of process flow 800 can be implemented by new computer feature prioritization component 108 of FIG. 1, or computing environment 1400 of FIG. 14.

It can be appreciated that the operating procedures of process flow 800 are example operating procedures, and that there can be embodiments that implement more or fewer operating procedures than are depicted, or that implement the depicted operating procedures in a different order than as depicted. In some examples, process flow 800 can be implemented in conjunction with one or more embodiments of one or more of process flow 600 of FIG. 6, process flow 700 of FIG. 7, process flow 900 of FIG. 9, process flow 1000 of FIG. 10, process flow 1100 of FIG. 11, process flow 1200 of FIG. 12, and/or process flow 1300 of FIG. 13.

Process flow 800 begins with 802, and moves to operation 804.

Operation 804 depicts determining whether a feature exists within the industry. In some examples, operation 804 can be implemented in a similar manner as feature exists within industry? (competitors) 224 of FIG. 2.

Where in operation 804 it is determined that the feature exists within the industry, process flow 800 moves to operation 806. Instead, where in operation 804 it is determined that the feature does not exist within the industry, process flow 800 moves to operation 808.

Operation 806 is reached from operation 804 where it is determined that the feature exists within the industry. Operation 806 depicts creating the feature request with a high priority. In some examples, operation 806 can be implemented in a similar manner as new feature request (high priority) 232 of FIG. 2.

After operation 806, process flow 800 moves to 810, where process flow 800 ends.

Operation 808 is reached from operation 804 where it is determined that the feature does not exist within the industry. Operation 808 depicts creating the feature request with a normal priority. In some examples, operation 808 can be implemented in a similar manner as new feature request (normal priority) 230 of FIG. 2.

After operation 808, process flow 800 moves to 810, where process flow 800 ends.

FIG. 9 illustrates an example process flow 900 for determining whether a feature priority is correct, and that can facilitate new computer feature prioritization, in accordance with an embodiment of this disclosure. In some examples, one or more embodiments of process flow 900 can be implemented by new computer feature prioritization component 108 of FIG. 1, or computing environment 1400 of FIG. 14.

It can be appreciated that the operating procedures of process flow 900 are example operating procedures, and that there can be embodiments that implement more or fewer operating procedures than are depicted, or that implement the depicted operating procedures in a different order than as depicted. In some examples, process flow 900 can be implemented in conjunction with one or more embodiments of one or more of process flow 600 of FIG. 6, process flow 700 of FIG. 7, process flow 800 of FIG. 8, process flow 1000 of FIG. 10, process flow 1100 of FIG. 11, process flow 1200 of FIG. 12, and/or process flow 1300 of FIG. 13.

Process flow 900 begins with 902, and moves to operation 904.

Operation 904 depicts determining whether a requested feature's priority is correct. In some examples, operation 904 can be implemented in a similar manner as feature priority correct? 226 of FIG. 2.

Where in operation 904 it is determined that the requested feature's priority is correct, process flow 900 moves to operation 908. Instead, where in operation 904 it is determined that the requested feature's priority is incorrect, process flow 900 moves to operation 906.

Operation 906 is reached from operation 904 where it is determined that the requested feature's priority is incorrect. Operation 906 depicts updating the requested feature's priority. In some examples, operation 906 can be implemented in a similar manner as update feature request (high priority) 234 of FIG. 2.

After operation 906, process flow 900 moves to 910, where process flow 900 ends.

Operation 908 is reached from operation 904 where it is determined that the requested feature's priority is correct. Operation 908 depicts not updating the requested feature's priority. In some examples, operation 908 can be implemented in a similar manner as no update to feature request priority 236 of FIG. 2.

After operation 908, process flow 900 moves to 910, where process flow 900 ends.

FIG. 10 illustrates an example process flow 1000 for determining whether a feature is relevant to multiple offerings, and that can facilitate new computer feature prioritization, in accordance with an embodiment of this disclosure. In some examples, one or more embodiments of process flow 1000 can be implemented by new computer feature prioritization component 108 of FIG. 1, or computing environment 1400 of FIG. 14.

It can be appreciated that the operating procedures of process flow 1000 are example operating procedures, and that there can be embodiments that implement more or fewer operating procedures than are depicted, or that implement the depicted operating procedures in a different order than as depicted. In some examples, process flow 1000 can be implemented in conjunction with one or more embodiments of one or more of process flow 600 of FIG. 6, process flow 700 of FIG. 7, process flow 800 of FIG. 8, process flow 900 of FIG. 9, process flow 1100 of FIG. 11, process flow 1200 of FIG. 12, and/or process flow 1300 of FIG. 13.

Process flow 1000 begins with 1002, and moves to operation 1004.

Operation 1004 depicts determining whether a requested feature is relevant to other offerings. In some examples, operation 1004 can be implemented in a similar manner as is feature relevant to other offerings? 444A and/or is feature relevant to other offerings? 444B of FIG. 4.

Where in operation 1004 it is determined that the requested feature is relevant to other offerings, process flow 1000 moves to operation 1008. Instead, where in operation 1004 it is determined that the requested feature is not relevant to other offerings, process flow 1000 moves to operation 1006.

Operation 1006 is reached from operation 1004 where it is determined that the requested feature is relevant to other offerings. Operation 1006 depicts updating or creating a single feature request. In some examples, operation 1006 can be implemented in a similar manner as single new feature request 446 and/or single update 450 of FIG. 4.

After operation 1006, process flow 1000 moves to 1010, where process flow 1000 ends.

Operation 1008 is reached from operation 1004 where it is determined that the requested feature is relevant to other offerings. Operation 1008 depicts updating or creating multiple feature requests. In some examples, operation 1008 can be implemented in a similar manner as multiple new feature requests 448 and/or multiple updates 452 of FIG. 4.

After operation 1008, process flow 1000 moves to 1010, where process flow 1000 ends.

FIG. 11 illustrates an example process flow 1100 that can facilitate new computer feature prioritization, in accordance with an embodiment of this disclosure. In some examples, one or more embodiments of process flow 1100 can be implemented by new computer feature prioritization component 108 of FIG. 1, or computing environment 1400 of FIG. 14.

It can be appreciated that the operating procedures of process flow 1100 are example operating procedures, and that there can be embodiments that implement more or fewer operating procedures than are depicted, or that implement the depicted operating procedures in a different order than as depicted. In some examples, process flow 1100 can be implemented in conjunction with one or more embodiments of one or more of process flow 600 of FIG. 6, process flow 700 of FIG. 7, process flow 800 of FIG. 8, process flow 900 of FIG. 9, process flow 1000 of FIG. 10, process flow 1200 of FIG. 12, and/or process flow 1300 of FIG. 13.

Process flow 1100 begins with 1102, and moves to operation 1104.

Operation 1104 depicts, as part of a support call regarding an issue with first computing equipment associated with a vendor identity corresponding to a vendor, determining that the issue with the first computing equipment is resolved via developing a new product feature, wherein the new product feature is omitted from the first computing equipment, and wherein the new product feature is omitted from computing equipment products associated with the vendor identity. This can be implemented in a similar manner as missing feature or enhancement? 214 of FIG. 2 and/or missing feature or enhancement? 414 of FIG. 4.

In some examples, operation 1104 comprises producing a prediction of the issue, wherein the determining that the issue with the first computing equipment is resolved via developing the new product feature is performed based on the prediction of the issue. This can be implemented in a similar manner as issue(s) prediction 202 of FIG. 2 and/or issue(s) prediction 402 of FIG. 4 producing retrieve relevant predictions.

After operation 1104, process flow 1100 moves to operation 1106.

Operation 1106 depicts determining whether the new product feature is identified in a future feature list, to produce a first result. In some examples, this can be implemented in a similar manner as feature already requested? 218 of FIG. 2 and/or feature already requested? 418 of FIG. 4.

After operation 1106, process flow 1100 moves to operation 1108.

Operation 1108 depicts, in response to the first result indicating that the new product feature is omitted from the future feature list, adding an identification of the new product feature to the future feature list. This can be similar to following the No branch from feature already requested? 218 of FIG. 2 and/or feature already requested? 418 of FIG. 4.

After operation 1108, process flow 1100 moves to operation 1110.

Operation 1110 depicts, in response to the first result indicating that the new product feature is identified in the future feature list, increasing a vote count for the new product feature. This can be similar to following the Yes branch from feature already requested? 218 of FIG. 2 and/or feature already requested? 418 of FIG. 4.

After operation 1110, process flow 1100 moves to operation 1112.

Operation 1112 depicts, after the determining of whether the new product feature is identified in the future feature list, determining whether the new product feature is offered as part of second computing equipment associated with a different vendor identity associated with a different vendor, to produce a second result. This can be implemented in a similar manner as feature exists within industry? (competitors) 224 of FIG. 2 and/or feature exists within industry? (competitors) 424 of FIG. 4.

After operation 1112, process flow 1100 moves to operation 1114.

Operation 1114 depicts, in response to the second result indicating that the new product feature is offered as part of the second computing equipment, increasing a priority value of the new product feature in the future feature list. This can be similar to following the Yes branch of feature exists within industry? (competitors) 224 of FIG. 2 and/or feature exists within industry? (competitors) 424 of FIG. 4.

In some examples, the new product feature is a first product feature, and wherein the increasing of the priority value of the new product feature in the future feature list comprises moving a first ranking of the first product feature above a second ranking of a second product feature in a ranking of the future feature list, and wherein the determining that the development of the new product feature is to occur is further based on the ranking of the future feature list. That is, changing a priority value for a first product feature can involve adjusting its rank relative to other product features.

After operation 1114, process flow 1100 moves to operation 1116.

Operation 1116 depicts, in response to the second result indicating that the new product feature is not offered as part of the second computing equipment, decreasing the priority value of the new product feature in the future feature list. This can be similar to following the No branch of feature exists within industry? (competitors) 224 of FIG. 2 and/or feature exists within industry? (competitors) 424 of FIG. 4.

In some examples, the new product feature is a first product feature, and wherein the decreasing of the priority value of the new product feature in the future feature list comprises moving a first ranking of the first product feature below a second ranking of a second product feature in a ranking of the future feature list, and wherein the determining that the development of the new product feature is to occur is further based on the ranking of the future feature list. That is, changing a priority value for a first product feature can involve adjusting its rank relative to other product features.

After operation 1116, process flow 1100 moves to operation 1118.

Operation 1118 depicts determining that development of the new product feature is to occur based on the vote count for the new product feature and based on the priority value of the new product feature in the future feature list. This can comprise using the future feature list to determine whether to implement certain features in a product, and in what order, and can involve a preference to implement higher-ranked features over implementing lower-ranked features.

In some examples, the new product feature is a first product feature, the issue is a first issue, the identification is a first identification, and operation 1118 comprises, based on determining that a second issue with third computing equipment is able to be resolved without addressing a second product feature that is omitted from the third computing equipment, refraining from adding a second identification of the second product feature to the future feature list. This can be implemented in a similar manner as no new feature required 228 of FIG. 2 and/or no new feature required 428 of FIG. 4.

In some examples, the producing of the second result occurs during the support call, and operation 1118 comprises, after the support call, determining whether the priority value of the new product feature is correct, to produce a third result, and in response to the third result indicating that the priority value of the new product feature is incorrect, updating the priority value of the new product feature. In some examples, operation 1118 comprises, in response to the third result indicating that the priority value of the new product feature is correct, maintaining the priority value of the new product feature without changing the priority value. This can be implemented in a similar manner as post-call phase 220 of FIG. 2 and/or post-call phase 420 of FIG. 4.

After operation 1118, process flow 1100 moves to 1120, where process flow 1100 ends.

FIG. 12 illustrates another example process flow 1200 that can facilitate new computer feature prioritization, in accordance with an embodiment of this disclosure. In some examples, one or more embodiments of process flow 1200 can be implemented by new computer feature prioritization component 108 of FIG. 1, or computing environment 1400 of FIG. 14.

It can be appreciated that the operating procedures of process flow 1200 are example operating procedures, and that there can be embodiments that implement more or fewer operating procedures than are depicted, or that implement the depicted operating procedures in a different order than as depicted. In some examples, process flow 1200 can be implemented in conjunction with one or more embodiments of one or more of process flow 600 of FIG. 6, process flow 700 of FIG. 7, process flow 800 of FIG. 8, process flow 900 of FIG. 9, process flow 1000 of FIG. 10, process flow 1100 of FIG. 11, and/or process flow 1300 of FIG. 13.

Process flow 1200 begins with 1202, and moves to operation 1204.

Operation 1204 depicts determining that an issue with computing equipment supplied by a vendor is able to be resolved via developing a new product feature, wherein the new product feature is omitted from the computing equipment, and wherein the new product feature is omitted from computing equipment products supplied by the vendor. In some examples, operation 1204 can be implemented in a similar manner as operation 1104 of FIG. 11.

After operation 1204, process flow 1200 moves to operation 1206.

Operation 1206 depicts, where the new product feature is omitted from a future feature list, adding an identification of the new product feature to the future feature list. In some examples, operation 1206 can be implemented in a similar manner as operation 1108 of FIG. 11.

After operation 1206, process flow 1200 moves to operation 1208.

Operation 1208 depicts, where the new product feature is identified in the future feature list, increasing a vote count for the new product feature. In some examples, operation 1208 can be implemented in a similar manner as operation 1110 of FIG. 11.

After operation 1208, process flow 1200 moves to operation 1210.

Operation 1210 depicts, where the new product feature is determined to be offered by a competitor to the vendor, increasing a priority value of the new product feature in the future feature list. In some examples, operation 1210 can be implemented in a similar manner as operation 1114 of FIG. 11.

After operation 1210, process flow 1200 moves to operation 1212.

Operation 1212 depicts, where the new product feature is determined not to be offered by the competitor to the vendor, decreasing the priority value of the new product feature in the future feature list. In some examples, operation 1212 can be implemented in a similar manner as operation 1116 of FIG. 11.

After operation 1212, process flow 1200 moves to operation 1214.

Operation 1214 depicts facilitating development of the new product feature based on the vote count for the new product feature and based on the priority value of the new product feature in the future feature list. In some examples, operation 1214 can be implemented in a similar manner as operation 1118 of FIG. 11.

In some examples, the future feature list comprises a first feature list for a first product, the vote count is a first vote count, operation 1214 comprises determining whether the new product feature is relevant to a second product, to produce a result, and where the result indicates that the new product feature is relevant to the second product, adding a second indication of the new product feature to a second feature list for the second product, or increasing a second vote count for the new product feature in the second feature list for the second product. This can be implemented in a similar manner as updating a future feature list for multiple products in FIG. 4.

In some examples, operation 1214 comprises, where the result indicates that the new product feature is not relevant to any product other than the first product, refraining from adding the second indication of the new product feature to another feature list that differs from the first feature list. This can be implemented in a similar manner as the No branch of is feature relevant to other offerings? 444A and/or is feature relevant to other offerings? 444B of FIG. 4.

In some examples, the priority value is a first priority value, and operation 1214 comprises maintaining the first priority value for the new product feature in the first feature list separately from maintaining a second priority value for the new product feature in the second feature list.

In some examples, the vote count is a first vote count, and operation 1214 comprises maintaining the first vote count for the new product feature in the first feature list separately from maintaining a second vote count for the new product feature in the second feature list.

In some examples, operation 1214 comprises maintaining first information for the new product feature in the first feature list separately from maintaining second information for the new product feature in the second feature list.

That is, for each product a separate feature list can be maintained with its own priority value, vote count, etc., for each feature.

In some examples, the determining of whether the new product feature is relevant to the second product is performed after determining whether the new product feature is omitted from the first feature list, and is performed after determining whether the new product feature is offered by the competitor to the vendor. This can be implemented in a similar manner as FIG. 4.

After operation 1214, process flow 1200 moves to 1216, where process flow 1200 ends.

FIG. 13 illustrates another example process flow 1300 that can facilitate new computer feature prioritization, in accordance with an embodiment of this disclosure. In some examples, one or more embodiments of process flow 1300 can be implemented by new computer feature prioritization component 108 of FIG. 1, or computing environment 1400 of FIG. 14.

It can be appreciated that the operating procedures of process flow 1300 are example operating procedures, and that there can be embodiments that implement more or fewer operating procedures than are depicted, or that implement the depicted operating procedures in a different order than as depicted. In some examples, process flow 1300 can be implemented in conjunction with one or more embodiments of one or more of process flow 600 of FIG. 6, process flow 700 of FIG. 7, process flow 800 of FIG. 8, process flow 900 of FIG. 9, process flow 1000 of FIG. 10, process flow 1100 of FIG. 11, and/or process flow 1200 of FIG. 12.

Process flow 1300 begins with 1302, and moves to operation 1304.

Operation 1304 depicts determining that an issue with computing equipment associated with a vendor identity of a vendor is able to be resolved by developing a new product feature. In some examples, operation 1304 can be implemented in a similar manner as operation 1104 of FIG. 11.

After operation 1304, process flow 1300 moves to operation 1306.

Operation 1306 depicts, based on the new product feature being determined to be omitted from a feature list of product features that have not yet been developed, adding an identification of the new product feature to the feature list. In some examples, operation 1306 can be implemented in a similar manner as operation 1108 of FIG. 11.

After operation 1306, process flow 1300 moves to operation 1308.

Operation 1308 depicts, based on the new product feature being determined to be identified in the feature list, increasing a vote count for the new product feature. In some examples, operation 1308 can be implemented in a similar manner as operation 1110 of FIG. 11.

After operation 1308, process flow 1300 moves to operation 1310.

Operation 1310 depicts, based on the new product feature being determined to be available via other equipment associated with another vendor identity of another vendor, increasing a priority value of the new product feature in the feature list. In some examples, operation 1310 can be implemented in a similar manner as operation 1114 of FIG. 11.

After operation 1310, process flow 1300 moves to operation 1312.

Operation 1312 depicts, based on the new product feature being determined not to be available via the other equipment, decreasing the priority value of the new product feature in the feature list. In some examples, operation 1312 can be implemented in a similar manner as operation 1116 of FIG. 11.

In some examples, the feature list comprises a first feature list for a first product, wherein the vote count is a first vote count, and operation 1312 comprises determining whether the new product feature is relevant to a second product, to produce a result, and, based on the new product feature being determined to be relevant to the second product, adding an indication of the new product feature to a second feature list for the second product, or increasing a second vote count for the new product feature in the second feature list for the second product.

In some examples, operation 1312 comprises refraining from adding the indication of the new product feature to any other feature list that differs from the first feature list, based on the new product feature being determined not to be relevant to any product other than the first product.

In some examples, the priority value is a first priority value, and the first priority value for the new product feature in the first feature list is maintained separately from a second priority value for the new product feature in the second feature list.

In some examples, the vote count is a first vote count, and the first vote count for the new product feature in the first feature list is maintained separately from a second vote count for the new product feature in the second feature list.

In some examples, the first vote count for the new product feature in the first feature list is maintained separately from the second vote count for the new product feature in the second feature list.

After operation 1312, process flow 1300 moves to 1314, where process flow 1300 ends.

### Example Operating Environment

In order to provide additional context for various embodiments described herein, FIG. 14 and the following discussion are intended to provide a brief, general description of a suitable computing environment 1400 in which the various embodiments of the embodiment described herein can be implemented.

For example, parts of computing environment 1400 can be used to implement one or more embodiments of service computer system 102 and/or user computer system 106,.

In some examples, computing environment 1400 can implement one or more embodiments of the process flows of FIGS. 6-13 to facilitate new computer feature prioritization.

While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can also be practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 14, the example environment 1400 for implementing various embodiments described herein includes a computer 1402, the computer 1402 including a processing unit 1404, a system memory 1406 and a system bus 1408. The system bus 1408 couples system components including, but not limited to, the system memory 1406 to the processing unit 1404. The processing unit 1404 can be any of various commercially available processors. Dual microprocessors and other multi-processor architectures can also be employed as the processing unit 1404.

The system bus 1408 can be any of several types of bus structure that can further interconnect to a memory bus (with or without a memory controller), a peripheral bus, and a local bus using any of a variety of commercially available bus architectures. The system memory 1406 includes ROM 1410 and RAM 1412. A basic input/output system (BIOS) can be stored in a nonvolatile storage such as ROM, erasable programmable read only memory (EPROM), EEPROM, which BIOS contains the basic routines that help to transfer information between elements within the computer 1402, such as during startup. The RAM 1412 can also include a high-speed RAM such as static RAM for caching data.

The computer 1402 further includes an internal hard disk drive (HDD) 1414 (e.g., EIDE, SATA), one or more external storage devices 1416 (e.g., a magnetic floppy disk drive (FDD) 1416, a memory stick or flash drive reader, a memory card reader, etc.) and an optical disk drive 1420 (e.g., which can read or write from a CD-ROM disc, a DVD, a BD, etc.). While the internal HDD 1414 is illustrated as located within the computer 1402, the internal HDD 1414 can also be configured for external use in a suitable chassis (not shown). Additionally, while not shown in environment 1400, a solid state drive (SSD) could be used in addition to, or in place of, an HDD 1414. The HDD 1414, external storage device(s) 1416 and optical disk drive 1420 can be connected to the system bus 1408 by an HDD interface 1424, an external storage interface 1426 and an optical drive interface 1428, respectively. The interface 1424 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1402, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1412, including an operating system 1430, one or more application programs 1432, other program modules 1434 and program data 1436. All or portions of the operating system, applications, modules, and/or data can also be cached in the RAM 1412. The systems and methods described herein can be implemented utilizing various commercially available operating systems or combinations of operating systems.

Computer 1402 can optionally comprise emulation technologies. For example, a hypervisor (not shown) or other intermediary can emulate a hardware environment for operating system 1430, and the emulated hardware can optionally be different from the hardware illustrated in FIG. 14. In such an embodiment, operating system 1430 can comprise one virtual machine (VM) of multiple VMs hosted at computer 1402. Furthermore, operating system 1430 can provide runtime environments, such as the Java runtime environment or the .NET framework, for applications 1432. Runtime environments are consistent execution environments that allow applications 1432 to run on any operating system that includes the runtime environment. Similarly, operating system 1430 can support containers, and applications 1432 can be in the form of containers, which are lightweight, standalone, executable packages of software that include, e.g., code, runtime, system tools, system libraries and settings for an application.

Further, computer 1402 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1402, e.g., applied at the application execution level or at the operating system (OS) kernel level, thereby enabling security at any level of code execution.

A user can enter commands and information into the computer 1402 through one or more wired/wireless input devices, e.g., a keyboard 1438, a touch screen 1440, and a pointing device, such as a mouse 1442. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1404 through an input device interface 1444 that can be coupled to the system bus 1408, but can be connected by other interfaces, such as a parallel port, an IEEE 1394 serial port, a game port, a USB port, an IR interface, a BLUETOOTH® interface, etc.

A monitor 1446 or other type of display device can also be connected to the system bus 1408 via an interface, such as a video adapter 1448. In addition to the monitor 1446, a computer typically includes other peripheral output devices (not shown), such as speakers, printers, etc.

The computer 1402 can operate in a networked environment using logical connections via wired and/or wireless communications to one or more remote computers, such as a remote computer(s) 1450. The remote computer(s) 1450 can be a workstation, a server computer, a router, a personal computer, portable computer, microprocessor-based entertainment appliance, a peer device or other common network node, and typically includes many or all of the elements described relative to the computer 1402, although, for purposes of brevity, only a memory/storage device 1452 is illustrated. The logical connections depicted include wired/wireless connectivity to a local area network (LAN) 1454 and/or larger networks, e.g., a wide area network (WAN) 1456. Such LAN and WAN networking environments are commonplace in offices and companies, and facilitate enterprise-wide computer networks, such as intranets, all of which can connect to a global communications network, e.g., the Internet.

When used in a LAN networking environment, the computer 1402 can be connected to the local network 1454 through a wired and/or wireless communication network interface or adapter 1458. The adapter 1458 can facilitate wired or wireless communication to the LAN 1454, which can also include a wireless access point (AP) disposed thereon for communicating with the adapter 1458 in a wireless mode.

When used in a WAN networking environment, the computer 1402 can include a modem 1460 or can be connected to a communications server on the WAN 1456 via other means for establishing communications over the WAN 1456, such as by way of the Internet. The modem 1460, which can be internal or external and a wired or wireless device, can be connected to the system bus 1408 via the input device interface 1444. In a networked environment, program modules depicted relative to the computer 1402 or portions thereof, can be stored in the remote memory/storage device 1452. It will be appreciated that the network connections shown are examples, and other means of establishing a communications link between the computers can be used.

When used in either a LAN or WAN networking environment, the computer 1402 can access cloud storage systems or other network-based storage systems in addition to, or in place of, external storage devices 1416 as described above. Generally, a connection between the computer 1402 and a cloud storage system can be established over a LAN 1454 or WAN 1456 e.g., by the adapter 1458 or modem 1460, respectively. Upon connecting the computer 1402 to an associated cloud storage system, the external storage interface 1426 can, with the aid of the adapter 1458 and/or modem 1460, manage storage provided by the cloud storage system as it would other types of external storage. For instance, the external storage interface 1426 can be configured to provide access to cloud storage sources as if those sources were physically connected to the computer 1402.

The computer 1402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### CONCLUSION

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches, and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations,” this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips...), optical discs (e.g., CD, DVD...), smart cards, and flash memory devices (e.g., card, stick, key drive...). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
at least one processor; and
at least one memory that stores executable instructions that, when executed by the at least one processor, facilitate performance of operations, comprising:
as part of a support call regarding an issue with first computing equipment associated with a vendor identity corresponding to a vendor, determining that the issue with the first computing equipment is resolved via developing a new product feature, wherein the new product feature is omitted from the first computing equipment, and wherein the new product feature is omitted from computing equipment products associated with the vendor identity;
determining whether the new product feature is identified in a future feature list, to produce a first result;
in response to the first result indicating that the new product feature is omitted from the future feature list, adding an identification of the new product feature to the future feature list;
in response to the first result indicating that the new product feature is identified in the future feature list, increasing a vote count for the new product feature;
after the determining of whether the new product feature is identified in the future feature list, determining whether the new product feature is offered as part of second computing equipment associated with a different vendor identity associated with a different vendor, to produce a second result;
in response to the second result indicating that the new product feature is offered as part of the second computing equipment, increasing a priority value of the new product feature in the future feature list;
in response to the second result indicating that the new product feature is not offered as part of the second computing equipment, decreasing the priority value of the new product feature in the future feature list; and
determining that development of the new product feature is to occur based on the vote count for the new product feature and based on the priority value of the new product feature in the future feature list.

2. The system of claim 1, wherein the new product feature is a first product feature, and wherein the increasing of the priority value of the new product feature in the future feature list comprises:
moving a first ranking of the first product feature above a second ranking of a second product feature in a ranking of the future feature list, and wherein the determining that the development of the new product feature is to occur is further based on the ranking of the future feature list.

3. The system of claim 1, wherein the new product feature is a first product feature, and wherein the decreasing of the priority value of the new product feature in the future feature list comprises:
moving a first ranking of the first product feature below a second ranking of a second product feature in a ranking of the future feature list, and wherein the determining that the development of the new product feature is to occur is further based on the ranking of the future feature list.

4. The system of claim 1, wherein the new product feature is a first product feature, wherein the issue is a first issue, wherein the identification is a first identification, and wherein the operations further comprise:
based on determining that a second issue with third computing equipment is able to be resolved without addressing a second product feature that is omitted from the third computing equipment, refraining from adding a second identification of the second product feature to the future feature list.

5. The system of claim 1, wherein the producing of the second result occurs during the support call, and wherein the operations further comprise:
after the support call, determining whether the priority value of the new product feature is correct, to produce a third result; and
in response to the third result indicating that the priority value of the new product feature is incorrect, updating the priority value of the new product feature.

6. The system of claim 5, wherein the operations further comprise:
in response to the third result indicating that the priority value of the new product feature is correct, maintaining the priority value of the new product feature without changing the priority value.

7. The system of claim 1, wherein the operations further comprise:
producing a prediction of the issue, wherein the determining that the issue with the first computing equipment is resolved via developing the new product feature is performed based on the prediction of the issue.

8. A method, comprising:
determining, by a system comprising at least one processor, that an issue with computing equipment supplied by a vendor is able to be resolved via developing a new product feature, wherein the new product feature is omitted from the computing equipment, and wherein the new product feature is omitted from computing equipment products supplied by the vendor;
where the new product feature is omitted from a future feature list, adding, by the system, an identification of the new product feature to the future feature list;
where the new product feature is identified in the future feature list, increasing, by the system, a vote count for the new product feature;
where the new product feature is determined to be offered by a competitor to the vendor, increasing, by the system, a priority value of the new product feature in the future feature list;
where the new product feature is determined not to be offered by the competitor to the vendor, decreasing, by the system, the priority value of the new product feature in the future feature list; and
facilitating, by the system, development of the new product feature based on the vote count for the new product feature and based on the priority value of the new product feature in the future feature list.

9. The method of claim 8, wherein the future feature list comprises a first feature list for a first product, wherein the vote count is a first vote count, and further comprising:
determining, by the system, whether the new product feature is relevant to a second product, to produce a result; and
where the result indicates that the new product feature is relevant to the second product,
adding, by the system, a second indication of the new product feature to a second feature list for the second product, or
increasing, by the system, a second vote count for the new product feature in the second feature list for the second product.

10. The method of claim 9, further comprising:
where the result indicates that the new product feature is not relevant to any product other than the first product, refraining from adding, by the system, the second indication of the new product feature to another feature list that differs from the first feature list.

11. The method of claim 9, wherein the priority value is a first priority value, and further comprising:
maintaining, by the system, the first priority value for the new product feature in the first feature list separately from maintaining a second priority value for the new product feature in the second feature list.

12. The method of claim 9, wherein the vote count is a first vote count, and further comprising:
maintaining, by the system, the first vote count for the new product feature in the first feature list separately from maintaining a second vote count for the new product feature in the second feature list.

13. The method of claim 9, further comprising:
maintaining, by the system, first information for the new product feature in the first feature list separately from maintaining second information for the new product feature in the second feature list.

14. The method of claim 9, wherein the determining of whether the new product feature is relevant to the second product is performed after determining whether the new product feature is omitted from the first feature list, and is performed after determining whether the new product feature is offered by the competitor to the vendor.

15. A non-transitory computer-readable medium comprising instructions that, in response to execution, cause a system comprising at least one processor to perform operations, comprising:
determining that an issue with computing equipment associated with a vendor identity of a vendor is able to be resolved by developing a new product feature;
based on the new product feature being determined to be omitted from a feature list of product features that have not yet been developed, adding an identification of the new product feature to the feature list;
based on the new product feature being determined to be identified in the feature list, increasing a vote count for the new product feature;
based on the new product feature being determined to be available via other equipment associated with another vendor identity of another vendor, increasing a priority value of the new product feature in the feature list; and
based on the new product feature being determined not to be available via the other equipment, decreasing the priority value of the new product feature in the feature list.

16. The non-transitory computer-readable medium of claim 15, wherein the feature list comprises a first feature list for a first product, wherein the vote count is a first vote count, and wherein the operations further comprise:
determining whether the new product feature is relevant to a second product, to produce a result; and
based on the new product feature being determined to be relevant to the second product,
adding an indication of the new product feature to a second feature list for the second product, or
increasing a second vote count for the new product feature in the second feature list for the second product.

17. The non-transitory computer-readable medium of claim 16, wherein the operations further comprise:
refraining from adding the indication of the new product feature to any other feature list that differs from the first feature list, based on the new product feature being determined not to be relevant to any product other than the first product.

18. The non-transitory computer-readable medium of claim 16, wherein the priority value is a first priority value, and wherein the first priority value for the new product feature in the first feature list is maintained separately from a second priority value for the new product feature in the second feature list.

19. The non-transitory computer-readable medium of claim 16, wherein the vote count is a first vote count, and wherein the first vote count for the new product feature in the first feature list is maintained separately from a second vote count for the new product feature in the second feature list.

20. The non-transitory computer-readable medium of claim 16, wherein the first vote count for the new product feature in the first feature list is maintained separately from the second vote count for the new product feature in the second feature list.
